(19) United States
(12) Patent Application Publication
(10) Pub. No.: US 2006/0252403 A1
(43) Pub. Date: Nov. 9, 2006

(54) Multi-mode receiver for a wireless communication system

(75) Inventor: Patrice Garcia, Crolles (FR)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(73) Assignee: STMICROELECTRONICS SA, MONTROUGE (FR)

(21) Appl. No.: 11/399,682

(22) Filed: Apr. 5, 2006

(30) Foreign Application Priority Data
Apr. 5, 2005 (FR) 05 03350

(51) Int. Cl. H04B 1/16; H04M 1/00

(52) U.S. Cl. 455/334; 455/552.1; 455/209

(57) ABSTRACT

A receiver is provided for a wireless communication system that is operable in at least a first mode of communication and a second mode of communication. The receiver includes an antenna for receiving a communication signal, a BAW resonator for receiving an RF signal provided at an output of the antenna, a low noise amplifier, and a mixer circuit coupled to the low noise amplifier. The low noise amplifier has an adjustable input or output impedance for interacting with operating characteristics of the first BAW resonator. The mixer circuit mixes an RF signal with a signal from a local oscillator so as to generate an intermediary frequency. The input impedance of the low noise amplifier is adjusted so as to operate the receiver in the first or second mode of communication. Also provided is a wireless communication device (such as a cellular phone) that includes such a receiver.

### CROSS-REFERENCE TO RELATED APPLICATIONS

This application is based upon and claims priority from prior French Patent Application No. 05 03350, filed Apr. 5, 2005, the entire disclosure of which is herein incorporated by reference.

### FIELD OF THE INVENTION

The present invention relates to telecommunications, and more specifically to a multi-mode receiver circuit for a wireless communication system.

### BACKGROUND OF THE INVENTION

Today there is an explosion of telecommunications in modern society, and the development without precedent of cellular phones, GSM and soon WCDMA phones.

More than ever, modern phones will be used to run through multiple standards, including future standards, but they must remain—as is the requirement today—cheap to realize.

FIG. 1 illustrates a typical architecture of a multi-mode phone, which is able to operate for European networks of type DCS and GSM and for the American network of type PCS, and even for the future network of type WCDMA. As shown in the figure, this result is obtained by juxtaposing in such a phone a set of separate circuits that take into account the distinctive frequencies that are specific to the different networks (i.e., 950 MHz for the GSM network, 1850 MHz for the DCS network, 1950 MHz for the PCS network, and 2150 MHz for the WCDMA network). To achieve this, the phone has a juxtaposition of several categories of circuits specific to each of the different frequencies. Here, there are three series of filters 11-13 (generally of Surface Acoustic Wave type resonators), three low noise amplifiers 21-23, and three amplifiers with transconductance 31 to 33. The WCDMA receiver circuit requires a supplementary filter 50 downstream of the amplifier 23.

While there can be realized a mixer 40 or common mixer to the three modes, it is necessary to consider as many units or filter chains as working frequencies, and consequently as communication modes.

The juxtaposition of several distinct circuits in the same unit is clearly a factor that increases the manufacture cost of the phone.

### SUMMARY OF THE INVENTION

It is an object of the present invention to provide an architecture for reconfigurable phone that is able to operate under multiple modes, but that stays cheap to manufacture.

Another object of the present invention is to reduce the complexity of wireless phones by providing a receiver circuit and a transmitter circuit for a reconfigurable phone based on a unique circuit resonator.

Still another object of the present invention is to provide a receiver circuit and a transmitter circuit for a cellular phone based on a BAW type resonator that allows coverage of several communication modes.

These objects are achieved in one embodiment by a receiver circuit for a wireless communication system having a first mode and a second mode of communication. The receiver circuit includes an antenna to receiving a communication signal, a BAW type resonator receiving the RF signal at the output of the antenna, a low noise amplifier (LNA), and a mixer circuit. The low noise amplifier presents an adjustable input impedance that is used to interact with the characteristics of operation of the BAW resonator, and the mixer circuit mixes the RF signal with the signal from a local oscillator to generate an intermediary frequency. The tuning of the input impedance of the low noise amplifier allows the regulation of the operation of the receiver circuit in the first or second communication mode.

The regulation of the input impedance of the LNA allows the setting of the operating characteristics of the BAW resonator in order to enable the operation of the circuit in the first and second modes. Thus, the same circuit can cover the multiple modes (e.g., DCS, GSM, and PCS).

Preferably, the circuit includes, between the low noise amplifier and the mixer circuit, a second BAW type resonator in order to also allow operation in a WCDMA mode.

In one embodiment, the low noise amplifier comprises a transconductance differential structure whose point of polarization is set to fix the input impedance.

Preferably, the transconductance amplifier comprises a first bipolar transistor having a base, a transmitter, and a collector; a second bipolar transistor having a base, a transmitter, and a collector, with the transmitter and collector of the second transistor being respectively connected to the transmitter and collector of the first transistor; a third bipolar transistor having a base, a transmitter, and a collector; a fourth bipolar transistor having a base, a transmitter, and a collector, with the transmitter and collector of the fourth transistor being respectively connected to the transmitter and collector of the third transistor; a current source having a first electrode and a second electrode connected to a reference potential; a first inductance having a first electrode connected to the transmitters of the first and second transistors and a second electrode connected to the first electrode of the current source; a second inductance having a first electrode connected to transmitter of the third and fourth transistors and a second electrode connected to the first electrode of the current source; a first resistance connected between the base of the first transistor and control potential V2; a second resistance connected between the base of the second transistor and control potential V1; a third resistance connected between the base of the third transistor and the control potential V2; a fourth resistance connected between the base of the fourth transistor and the control potential V1; a first decoupling capacity connected between the base of the first transistor and the component in phase of the RF signal; a second decoupling capacity connected between the base of the second transistor and the component in phase of the RF signal; a third decoupling capacity connected between the base of the third transistor and the component in phase of RF signal; and a fourth decoupling capacity connected between the base of the fourth transistor and the component in opposition of phase of RF signal.

Other objects, features, and advantages of the present invention will become apparent from the following detailed description. It should be understood, however, that the detailed description and specific examples, while indicating preferred embodiments of the present invention, are given by way of illustration only and various modifications may naturally be performed without deviating from the present invention.

### BRIEF DESCRIPTION OF THE DRAWINGS

FIG. 1 illustrates a conventional architecture of a reconfigurable multi-mode phone.

FIG. 2 illustrates a receiver circuit according to a preferred embodiment of the present invention that allows the reception of WCDMA signals.

FIG. 3 illustrates a receiver circuit according to another embodiment of the present invention.

FIG. 4 illustrates an exemplary embodiment of the low noise amplifier circuit.

FIG. 5 illustrates an exemplary embodiment of the amplifier circuit that has a BAW resonator between the collectors of two differential pairs.

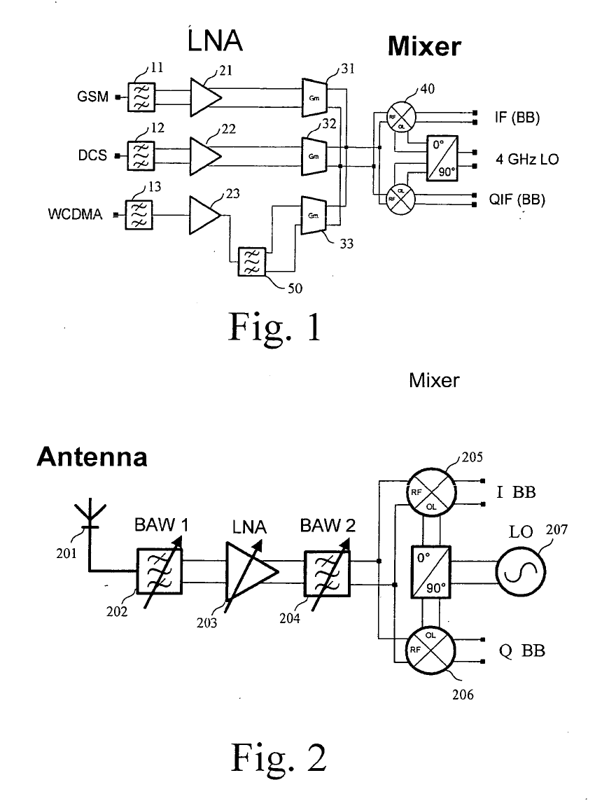

### DETAILED DESCRIPTION OF PREFERRED EMBODIMENTS

Preferred embodiments of the present invention will be described in detail hereinbelow with reference to the attached drawings.

There will now be described with reference to FIG. 2 a receiver circuit according to a preferred embodiment of the present invention. The circuit comprises an antenna 201, followed by a first BAW component 202 that receives the RF signal at the output of the antenna. A BAW (Bulk Acoustic Resonator) component is a resonator placed inside a delimited volume between an inferior electrode and a superior electrode so that the acoustic wave develops in that same volume. Downstream of the first BAW component 202, the circuit comprises a low noise amplifier LNA 203 for amplifying the RF signal.

According to embodiments of the present invention, the low noise amplifier 203 is selected so as to present an adjustable impedance in order to interact with the frequency characteristics of the first BAW component 202.

In this preferred embodiment, a second BAW component 204 is provided for the WCDMA communication mode. In this embodiment there is a deactivation system for that second BAW 204 because that component is only required for the WCDMA format and not for the GSM, DCS, or PCS formats.

The receiver circuit also comprises a mixer circuit (or mixer) that comprises a local oscillator LO 207 (set for example to 2 GHz) for generating a signal OL which is then mixed, in phase and in squaring (quadrature), with the RF signal by two mixers 205 and 206 in order to generate, at the output, the two components of the intermediary frequency IF.

One of the surprising elements of the present invention is that by using an amplifier circuit LNA having an adjustable impedance, it is possible to interact directly with the characteristics of the first BAW circuit and, then, to determine the operating frequency.

In order to vary the operating frequency of the filter made of the unique BAW resonator 202, first an inductance integrated in parallel with the BAW is inserted in order to achieve the cancellation of the frequency of parallel resonance. In simulation, it can be demonstrated that a quality factor of 30 can be attained, which is suitable. Second, the frequency of serial resonance is adjusted through a capacity, which is realized with a parasitic capacitance in output of a transistor (more specifically, capacities Csub and Cbc, respectively capacity collector-substrate and collector-base, of the junction b-c inversed polarized). The value of that capacity can be adjusted by adjusting the surface of the transistor. In practice, it is typical to place a matrix of transistors in parallel, with these transistors being controlled by their base potentials by command bits.

It is important to notice that the difference between the central frequencies will be higher than the ratio of output capacities of transistors Csub and Cbc will be large. That limitation is identical to those observed in oscillators controlled by varactor. In other terms, this type of assembly will cover two reception standards that are more and more spaced in frequency, on condition however that two conditions are joined together: 1) the value of the parasite capacity collector-substrate Csub needs to be low, and 2) the junction capacity Cbc base-collector needs to present a large sensitivity to the base-transmitter potential.

With these assumptions, there can then be considered a unique BAW 302 that matches the requirements of several communication modes, such as the DCS, GSM, PCS, and WCDMA modes in this illustrative embodiment. It is no longer necessary to consider as many filter chains as communication modes. Thus, the cost of manufacture of the receiver circuit is considerably reduced.

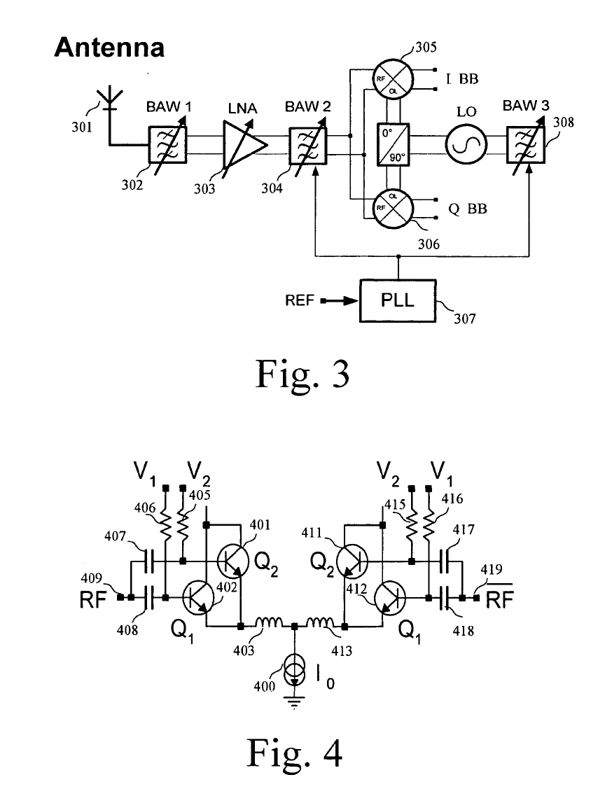

FIG. 3 illustrates another embodiment of the present invention in which a third BAW resonator 308 and a Phase Locked Loop (PLL) circuit 307 are inserted in the structure. As shown, the receiver circuit comprises an antenna 301, a first BAW 302, a low noise amplifier LNA 303, a second BAW circuit 304 which can be disconnected, and a mixer based on mixers 305 and 306. As shown in the figure, the PLL circuit 307 serves to adjust the frequency of the second BAW 304 and also that of the third BAW 308. The PLL circuit 307 is thus used to adjust the frequency characteristics of the whole filter. This calibration is based on a master-slave principle in which the whole filter is used to regulate the operating frequency of an oscillator, this being controlled by a phase locked loop. Thus, the oscillation frequency will correspond to the resonance frequency of the filter; the control potential of the PLL circuit is then reused to adjust precisely the resonance frequency of the resonator.

In a preferred embodiment of the present invention, the amplifier circuit LNA is realized by a differential structure of amplification at transconductance with the polarization point fixed in order to regulate the input impedance of the circuit.

An exemplary embodiment of a low noise amplifier is illustrated in FIG. 4. As shown, a first differential pair Q2 made of bipolar transistors 401 and 411 (for example of NPN type), is associated with a second differential pair Q1 made of transistors 402 and 412 (for example also of NPN type). One of ordinary skill in the art can adapt the circuit to transistors of opposite type (i.e., PNP).

Transistor 401 (402) has its base connected to a first electrode of a resistance 405 (406) and to a first electrode of a decoupling capacity 407 (408). Similarly, transistor 411 (412) has its base connected to a first electrode of a resistance 415 (416) and to a first electrode of a decoupling capacity 417 (419).

Transistors 401 and 402 (411 and 412) each have an emitter electrode that is connected to a first electrode of inductance 403 (413), whose second electrode is a mass through a current source 400 that delivers a current I0.

The collectors of transistors 401 and 402 (411 and 412) are connected to a first output electrode (a second electrode) of the differential amplifier.

Decoupling capacities 407 and 408 each have a second electrode that receives the first half of the RF signal.

Decoupling capacities 417 and 418 each have a second electrode that receives the second half, in opposite phase, of the RF signal.

Resistances 405 and 415 each have a second electrode that receives a control potential V2. Similarly, resistances 406 and 416 each have a second electrode that receives a control potential V1.

The low noise amplifier circuit of FIG. 4 is such that in controlling potentials V1 or V2, the polarization point of transistors Q1 and Q2 can be modified and, in consequence, the input impedance of the LNA circuit can be controlled.

Thus, that impedance interacts with the characteristics of BAW 202 to allow the adjustment of the operating frequency of the receiver circuit.

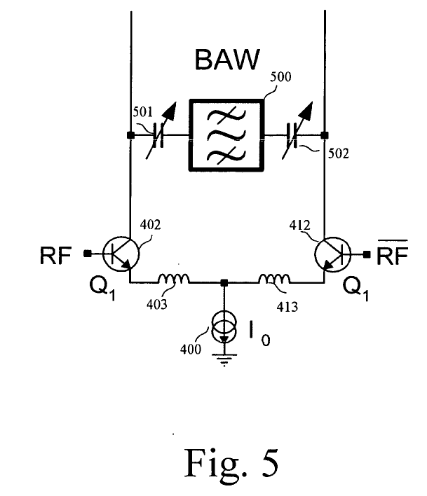

With reference to FIG. 5, there will now be described an embodiment in which there is connected, between the collectors of a pair of transistors 402 and 412, a circuit comprising the serial connection of a first adjustable capacity 501, followed by a BAW type resonator 500, followed by a second adjustable capacity 502.

We can thus realize, very simply, the receiver circuit with the elements 202, 203, and 204.

This circuit can be used very simply to realize a reconfigurable multi-mode phone, using a common chain for the reception of all modes.

While there has been illustrated and described what are presently considered to be the preferred embodiments of the present invention, it will be understood by those skilled in the art that various other modifications may be made, and equivalents may be substituted, without departing from the true scope of the present invention. Additionally, many modifications may be made to adapt a particular situation to the teachings of the present invention without departing from the central inventive concept described herein. Furthermore, an embodiment of the present invention may not include all of the features described above. Therefore, it is intended that the present invention not be limited to the particular embodiments disclosed, but that the invention include all embodiments falling within the scope of the appended claims.

What is claimed is:

1. A receiver for a wireless communication system that is operable in at least a first mode of communication and a second mode of communication, the receiver comprising:
an antenna for receiving a communication signal;
a first BAW resonator for receiving an RF signal provided at an output of the antenna;
a low noise amplifier having an adjustable input or output impedance for interacting with operating characteristics of the first BAW resonator; and
a mixer circuit coupled to the low noise amplifier, the mixer circuit mixing an RF signal with a signal from a local oscillator so as to generate an intermediary frequency,
wherein the input impedance of the low noise amplifier is adjusted so as to operate the receiver in the first or second mode of communication.

2. The receiver according to claim 1, further comprising a second BAW resonator coupled between the low noise amplifier and the mixer circuit so as to allowing operation in a WCDMA mode.

3. The receiver according to claim 1, wherein the low noise amplifier comprises a transconductance differential structure, a polarization point of the transconductance differential structure or the number of elements placed in parallel being adjusted to set the input impedance of the low noise amplifier.

4. The receiver according to claim 1, wherein the first and second modes of communication are two modes selected from the group of DCS, GSM, PCS, and WCDMA.

5. The receiver according to claim 1, wherein the low noise amplifier comprises:
a first bipolar transistor comprising a base, an emitter, and a collector;
a second bipolar transistor comprising a base, an emitter, and a collector, the emitter and collector of the second transistor being respectively connected to the emitter and collector of the first transistor;
a third bipolar transistor comprising a base, an emitter and a collector;
a fourth bipolar transistor (412) comprising a base, an emitter, and a collector; the emitter and collector of the fourth transistor being respectively connected to the emitter and collector of the third transistor;
a current source having a first electrode and a second electrode connected to a reference potential;
a first inductance comprising a first electrode connected to the emitters of the first and second transistors and a second electrode connected to the first electrode of the current source;
a second inductance comprising a first electrode connected to the emitters of the third and fourth transistors and a second electrode connected to the first electrode of the current source;
a first resistance connected between the base of the first transistor and a first control potential;
a second resistance connected between the base of the second transistor and a second control potential;
a third resistance connected between the base of the third transistor and the first control potential;
a fourth resistance connected between the base of the fourth transistor and the second control potential;
a first decoupling capacity connected between the base of the first transistor and the phase component of the RF signal;
a second decoupling capacity connected between the base of the second transistor and the phase component of the RF signal;
a third decoupling capacity connected between the base of the third transistor and the component in phase opposition of the RF signal; and
a fourth decoupling capacity connected between the base of the fourth transistor and the component in phase opposition of the RF signal,
wherein the first and second control potentials adjust the input impedance of the low noise amplifier.

6. The receiver according to claim 5, wherein the first, second, third, and fourth transistors are bipolar NPN transistors.

7. The receiver according to claim 5, wherein a first circuit is connected between the collectors of the second and fourth transistors, the first circuit comprising a first adjustable capacity, a BAW resonator, and a second adjustable capacity.

8. A wireless communication device including a receiver circuit, the wireless communication device being operable in at least a first mode of communication and a second mode of communication, the receiver circuit comprising:
an antenna for receiving a communication signal;
a first BAW resonator for receiving an RF signal provided at an output of the antenna;
a low noise amplifier having an adjustable input or output impedance for interacting with operating characteristics of the first BAW resonator; and
a mixer circuit coupled to the low noise amplifier, the mixer circuit mixing an RF signal with a signal from a local oscillator so as to generate an intermediary frequency,
wherein the input impedance of the low noise amplifier is adjusted so as to operate the receiver circuit in the first or second mode of communication.

9. The wireless communication device according to claim 8, wherein the receiver circuit further comprises a second BAW resonator coupled between the low noise amplifier and the mixer circuit so as to allowing operation in a WCDMA mode.

10. The wireless communication device according to claim 8, wherein the low noise amplifier of the receiver circuit comprises a transconductance differential structure, a polarization point of the transconductance differential structure or the number of elements placed in parallel being adjusted to set the input impedance of the low noise amplifier.

11. The wireless communication device according to claim 8, wherein the first and second modes of communication are two modes selected from the group of DCS, GSM, PCS, and WCDMA.

12. The wireless communication device according to claim 8, wherein the low noise amplifier of the receiver circuit comprises:
a first bipolar transistor comprising a base, an emitter, and a collector;
a second bipolar transistor comprising a base, an emitter, and a collector, the emitter and collector of the second transistor being respectively connected to the emitter and collector of the first transistor;
a third bipolar transistor comprising a base, an emitter and a collector;
a fourth bipolar transistor (412) comprising a base, an emitter, and a collector; the emitter and collector of the fourth transistor being respectively connected to the emitter and collector of the third transistor;
a current source having a first electrode and a second electrode connected to a reference potential;
a first inductance comprising a first electrode connected to the emitters of the first and second transistors and a second electrode connected to the first electrode of the current source;
a second inductance comprising a first electrode connected to the emitters of the third and fourth transistors and a second electrode connected to the first electrode of the current source;
a first resistance connected between the base of the first transistor and a first control potential;
a second resistance connected between the base of the second transistor and a second control potential;
a third resistance connected between the base of the third transistor and the first control potential;
a fourth resistance connected between the base of the fourth transistor and the second control potential;
a first decoupling capacity connected between the base of the first transistor and the phase component of the RF signal;
a second decoupling capacity connected between the base of the second transistor and the phase component of the RF signal;
a third decoupling capacity connected between the base of the third transistor and the component in phase opposition of the RF signal; and
a fourth decoupling capacity connected between the base of the fourth transistor and the component in phase opposition of the RF signal,
wherein the first and second control potentials adjust the input impedance of the low noise amplifier.

13. The wireless communication device according to claim 12, wherein the first, second, third, and fourth transistors of the low noise amplifier of the receiver circuit are bipolar NPN transistors.

14. The wireless communication device according to claim 12, wherein a first circuit is connected between the collectors of the second and fourth transistors of the low noise amplifier of the receiver circuit, the first circuit comprising a first adjustable capacity, a BAW resonator, and a second adjustable capacity.

15. The wireless communication device according to claim 8, wherein the wireless communication device is a cellular phone.
